(19) United States
(12) Patent Application Publication
(10) Pub. No.: US 2026/0014459 A1
(43) Pub. Date: Jan. 15, 2026

(54) METHODS, SYSTEMS AND NON-TRANSITORY COMPUTER-READABLE STORAGE DEVICES FOR CLOUD-BASED GAME GRAPHICS PROCESSING AND SYNCHRONIZATION

(71) Applicant: HUAWEI TECHNOLOGIES CO., LTD., Shenzhen (CN)

(72) Inventors: Shunguang Ding, White Rock (CA); Ali Asif, Burnaby (CA); Luming Yang, Burnaby (CA); Mahdi Davoodikakhki, Port Coquitlam (CA); Jia Yi Gu, Burnaby (CA)

(21) Appl. No.: 18/770,841

(22) Filed: Jul. 12, 2024

(51) Int. Cl. A63F 13/355; A63F 13/358; A63F 13/52; G06T 15/50

(52) U.S. Cl. CPC A63F 13/355; A63F 13/52; G06T 15/506; A63F 13/358

(57) ABSTRACT

Methods, servers, and systems for enhancing the performance of gaming applications through cloud computing. The method comprises receiving user information, which includes object states or visual effect data related to a game, from at least one user. Based on the specific game channel in which the user is playing, the method determines whether the user information requires processing by cloud computing. If cloud computing is required, the user information is transmitted to a computing server. The computing server processes the user information to generate graphics-related results, which are then transmitted back to the user's device for rendering, optimizing the gaming experience by leveraging cloud resources while minimizing the computational load on the user's device.

### FIELD OF THE DISCLOSURE

The present disclosure relates generally to cloud computing and game graphics rendering, and in particular to methods, systems, and non-transitory computer-readable storage devices for processing and synchronizing user information, including object states and visual effect data, to generate graphics-related results in a multi-user gaming environment.

### BACKGROUND

According to Moore's Law, the number of transistors on a microchip doubles every two years, increasing the speed and power of computers while making them more affordable. This evolution has enabled mobile phones and personal computers to have significantly more processing power than in previous years, allowing applications to expand in terms of features, highly realistic graphics, and complex calculations or processing techniques.

Low-end devices, typically designed for basic tasks such as web browsing, email, and social media, have limited processing power, memory, and storage capacity. In contrast, high-end devices are built for more demanding tasks, such as video editing, gaming, and scientific simulation, and have more powerful processors, larger memory, and faster storage. The difference between low-end and high-end devices is driven by factors such as the cost of hardware components, manufacturing processes, use cases, size and portability, and research and development costs.

The gaming industry has consistently strived to achieve high fidelity graphics without overloading the local hardware, particularly to bring high-quality gaming to low-end devices. The challenge is to overcome the inherent limitations of low-end devices while still delivering a rich and immersive gaming experience.

### SUMMARY

According to a first aspect of this disclosure, there is provided a method, comprising: receiving user information from at least one user, the user information comprising at least one of an object state or visual effect data related to a game; determining, based on a channel of the game in which the at least one user is playing, whether the user information of the at least one user requires cloud computing for processing; and in response to determining that the user information requires cloud computing, transmitting the user information of the at least one user to a computing server for processing the user information to generate graphics-related results for the channel.

In some embodiments, in response to determining that the user information requires cloud computing, the computing server may process at least one of the object state or the visual effect data using a request from the at least one user.

In some embodiments, in response to determining that the user information requires cloud computing, the computing server may process the object state or the visual effect data of the at least one user that has been changed compared to a previous frame.

In some embodiments, determining whether the user information of the at least one user may require cloud computing for processing comprises identifying one or more users of the at least one user in a same channel of the game as requiring cloud computing.

In some embodiments, the method may further comprise caching the received user information and performing the determination upon receiving all object states and visual effect data of all of the at least one user in a same channel of the game for a frame.

In some embodiments, the method may further comprise converting a format of at least one of the object state or the visual effect data of the at least one user to ensure that the at least one of the object state or the visual effect data of all of the at least one user have a same format.

In some embodiments, the method may further comprising receiving a request from the at least one user, the request may be for a rendering process to be performed by the computing server, the rendering process being at least one of global illumination, planar reflection, or probe reflection; the object state may comprise at least one of animation state, physics state, health state, inventory state, power state; and the visual effect data may comprise at least one of transform data, light probes, reflection probes, probe volumes, baked probes, or probe blending.

In some embodiments, the graphics-related results may comprise rendering results and computation results, the rendering results being information on at least one of global illumination, planar reflection, or probe reflection, and the computation results being information on at least one of A* (or “A-star”) pathfinding or machine learning-powered agent.

In some embodiments, the method may further comprise receiving the graphics-related results from the computing server; and transmitting the graphics-related results to a user device associated with the at least one user for loading on the user device.

According to a second aspect of this disclosure, there is provided a server comprising: a state synchronization unit for receiving user information from at least one user, the user information comprising at least one of an object state or visual effect data related to a game; a multi-user experience unit for determining, based on a channel of the game in which the at least one user is playing, whether the user information of the at least one user requires cloud computing for processing; and a computing unit for, in response to determining that the user information requires cloud computing, receiving the user information of the at least one user and processing the user information to generate graphics-related results for the channel.

In some embodiments, in response to determining that the user information requires cloud computing, the computing unit may process at least one of the object state or the visual effect data using a request from the at least one user.

In some embodiments, in response to determining that the user information requires cloud computing, the computing unit may process the object state or the visual effect data of the at least one user that has been changed compared to a previous frame.

In some embodiments, the multi-user experience unit may identify one or more users of the at least one user in a same channel of the game as requiring cloud computing.

In some embodiments, the state synchronization unit may comprise a buffer for caching the received user information and performs the determination upon receiving all object states and visual effect data of all of the at least one user in a same channel of the game for a frame.

In some embodiments, the state synchronization unit may comprise a converter for converting a format of at least one of the object state or the visual effect data of the at least one user to ensure that the at least one of the object state or the visual effect data of all of the at least one user have a same format.

In some embodiments, the state synchronization unit may further receive a request from the at least one user, the request may be for a rendering process to be performed by the computing unit, the rendering process being at least one of global illumination, planar reflection, or probe reflection; the object state may comprise at least one of animation state, physics state, health state, inventory state, power state; and the visual effect data may comprise at least one of transform data, light probes, reflection probes, probe volumes, baked probes, or probe blending.

In some embodiments, the graphics-related results may comprise rendering results and computation results, the rendering results being information on at least one of global illumination, planar reflection, or probe reflection, and the computation results being information on at least one of an A* pathfinding agent or a machine learning-powered agent.

In some embodiments, the state synchronization unit may further receive the graphics-related results from the computing unit and send the graphics-related results to a user device associated with the at least one user for loading.

According to a third aspect of this disclosure, there is provided a system comprising: a user device associated with at least one user; a state synchronization server for receiving user information from the at least one user, the user information comprising at least one of an object state or visual effect data related to a game; a multi-user experience server for determining, based on a channel of the game in which the at least one user is playing, whether the user information of the at least one user requires cloud computing for processing; and a computing server for, in response to determining that the user information requires cloud computing, receiving the user information of the at least one user and processing the user information to generate graphics-related results for the channel.

In some embodiments, in response to determining that the user information requires cloud computing, the computing server may process at least one of the object state or the visual effect data using a request from the at least one user.

In some embodiments, in response to determining that the user information requires cloud computing, the computing server may process the object state or the visual effect data of the at least one user that has been changed compared to a previous frame.

In some embodiments, the multi-user experience server may identify one or more users of the at least one user in a same channel of the game as requiring cloud computing.

In some embodiments, the state synchronization server may comprise a buffer for caching the received user information and performs the determination upon receiving all object states and visual effect data of all of the at least one user in a same channel of the game for a frame.

In some embodiments, the state synchronization server may comprise a converter for converting a format of at least one of the object state or the visual effect data of the at least one user to ensure that the at least one of the object state or the visual effect data of all of the at least one user have a same format.

In some embodiments, the state synchronization server may further receive a request from the at least one user, the request may be for a rendering process to be performed by the computing server, the rendering process being at least one of global illumination, planar reflection, or probe reflection; the object state may comprise at least one of animation state, physics state, health state, inventory state, power state; and the visual effect data may comprise at least one of transform data, light probes, reflection probes, probe volumes, baked probes, or probe blending.

In some embodiments, the graphics-related results may comprise rendering results and computation results, the rendering results being information on at least one of global illumination, planar reflection, or probe reflection, and the computation results being information on at least one of A* pathfinding or machine learning-powered agent.

In some embodiments, the state synchronization server may further receive the graphics-related results from the computing server and send the graphics-related results to the user device for loading.

In some embodiments, the state synchronization server, the multi-user experience server, and the computing server may be spatially distinct servers.

According to a fourth aspect of this disclosure, there is provided one or more non-transitory computer-readable storage devices comprising computer-executable instructions, wherein the instructions, when executed, cause one or more circuits to perform actions comprising: receiving user information from at least one user, the user information comprising at least one of an object state or visual effect data related to a game; determining, based on a channel of the game in which the at least one user is playing, whether the user information of the at least one user requires cloud computing for processing; and in response to determining that the user information requires cloud computing, transmitting the user information of the at least one user to a computing server for processing the user information to generate graphics-related results for the channel.

With above-described features, the solutions disclosed herein may provide several advantages. These include optimizing bandwidth usage by selectively offloading computationally intensive tasks to cloud servers, thereby reducing the processing load on client devices. This approach enables real-time synchronization of object states between the client and the cloud, ensuring consistency and accuracy in the gaming experience. By pre-computing complex graphical data such as lighting, reflections and shadows on powerful remote servers, the system improves visual fidelity and performance, delivering a smoother and more immersive experience on devices that have weaker computational power. It also facilitates efficient multi-user interactions by processing only relevant data, improving scalability and responsiveness. Overall, the disclosed solutions ensure high-fidelity cloud gaming that balances computational efficiency and visual excellence.

This summary does not necessarily describe the full scope of all aspects. Other aspects, features and advantages will become apparent to those of ordinary skill in the art upon review of the following description of specific embodiments.

### BRIEF DESCRIPTION OF THE DRAWINGS

For a more complete understanding of the disclosure, reference is made to the following description and accompanying drawings, in which:

FIG. 1 is a simplified schematic diagram of a process for cloud gaming, according to some embodiments of this disclosure.

FIG. 2 is a detailed process flow for cloud-based gaming, according to some embodiments of this disclosure.

FIG. 3 is a process flow for cloud-based gaming with the addition of a multi-user experience service, according to some embodiments of this disclosure.

FIG. 4 is a flowchart depicting the operation of the state synchronization service, according to some embodiments of this disclosure.

FIG. 5 is an architecture of custom-made libraries and packages designed to facilitate and support the general use cases of various services, according to some embodiments of this disclosure.

### DETAILED DESCRIPTION

In today's computing systems, cloud computing has become an essential technology that provides users with on-demand access to computing resources, including data storage and processing power, without requiring direct management by the user. Cloud computing systems are typically structured with a front-end platform, back-end platforms, a cloud-based delivery system, and a network. Large-scale cloud systems are distributed across multiple locations, each containing a data center.

Cloud gaming services use cloud computing to overcome the limitations of user devices that are not capable of running and rendering games at high resolutions and frame rates. In a typical cloud gaming setup, user input is sent to the cloud where the game is executed and rendered. The final rendered frames are then sent back to the user's device, effectively simulating the experience of running the game locally.

Some techniques have been introduced in this field to facilitate cloud gaming. For example, Virtual Desktop Infrastructure (VDI) has been used, which allows users to access their desktop environment remotely from any device. VDI centralizes the desktop environment on a server or cloud infrastructure, providing benefits such as increased scalability, centralized management, and enhanced security. Despite these benefits, VDI can be complex to set up and maintain, especially for large-scale deployments, and typically supports only one desktop per user. High-performance computing (HPC) systems are used for data processing and high-speed computing. HPC systems implement clusters of compute and control nodes to process tasks in parallel, balancing the load and improving computational speed.

Despite these advances, there are several drawbacks associated with current cloud computing solutions in gaming. One significant drawback is the reliance on a stable network connection. Applications that rely on cloud computing often experience higher latency and delayed responses compared to local applications. In addition, sending all calculations and requests to the server side can result in high bandwidth demands and pressure on cloud systems. There is no standard solution for efficiently synchronizing user states and inputs with different services, complicating application development and increasing the time and effort required. Existing solutions are often limited by specific hardware architectures and fail to provide a comprehensive approach for real-time offloading of compute-intensive tasks for multiple users.

The disclosure addresses these challenges by optimizing bandwidth usage and selectively offloading specific high-compute jobs to the computing/rendering service, rather than transmitting all inputs and results. This approach integrates various packages and services and ensures that the required data is transmitted only once, resulting in low latency and stable application performance even under fluctuating network conditions.

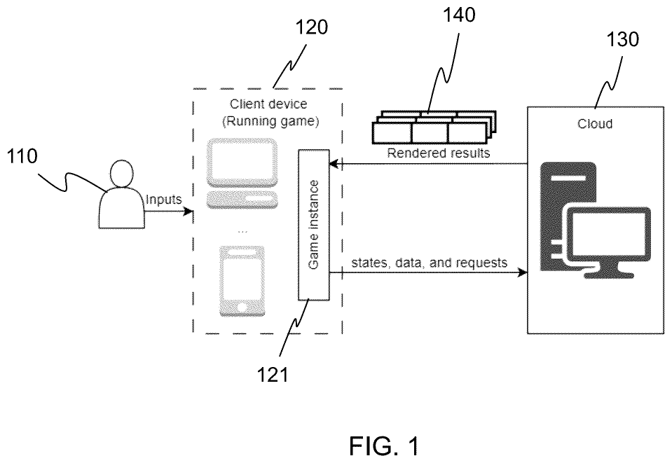

Referring now to FIG. 1, the figure illustrates a simplified schematic diagram of a process for cloud gaming according to the present disclosure. The process begins with a user's 110 inputs and culminates in a display of rendered results on a client device 120.

The process begins when the user 110 provides inputs via the client device 120, which may be a mobile device, such as a smartphone, a personal computer (PC), or another suitable computing device capable of running the game. These user inputs may include commands that alter the user's 110 gaming character's status, such as a movement command or a shooting command. The inputs are transmitted from an instance 121 of the game. The client device 120 generates user information from these inputs, which may include at least one of object states or visual effect data related to the game for rendering the game experience. Optionally, a request is also transmitted from the client device 120 on what rendering or computation is to be performed by cloud computing. Alternatively, user input may not be necessary for the transmission of user information; the user's 110 gaming character does not need to change its status. For example, the user information can still be transmitted in response to changes in other characters, such as other players' characters or non-player characters (NPCs).

In the context of this disclosure, the term “object state” refers to the specific properties and conditions of a game object, such as a 3-dimensional (3D) character, at a given time for rendering and gameplay mechanics. An object state may encompass various attributes that define the current status and behavior of the object within the game environment. These attributes include, but are not limited to, the transform data, which includes information about the object's scale, position, orientation, and rotation in a 3D environment; particle states, which define the behavior and appearance of particle systems such as smoke, fire, or magic effects; and the animation state, describing the current animation being executed. Examples of animation states include walking (character is moving with leg and arm movements), jumping (character is in mid-air with a defined arc and landing animation), attacking (character is performing an attack with specific frames for weapon swing and impact), idling (character is standing still with subtle movements), and dying (character is undergoing a death animation).

Additionally, the object state may encompass the physics state of the object, detailing its interactions with the game environment, such as moving (object is in motion with velocity and direction), stationary (object is not moving), falling (object is descending due to gravity), colliding (object is in contact with another object with details about the collision), and resting (object is stationary on a surface). Health state may be another attribute, reflecting the character's vitality, including full health (maximum health points), damaged (specific remaining health value after taking damage), critical (very low health close to death), and dead (no remaining health, character is no longer functioning).

The inventory state provides information about the items the player possesses, with states such as empty (no items in inventory), has weapon (specific weapon equipped), has potion (healing or consumable item available), and full (inventory cannot hold more items). Power state describes the effects of power-ups on the character, including active (enhanced abilities due to a power-up), inactive (normal state after power-up expiration), available (power-up item present in the environment), and collected (power-up item picked up by the player).

These properties collectively contribute to the dynamic and interactive nature of the game. For instance, an object state may capture a scenario where a character is positioned at the edge of a cliff, facing north, with health reduced to fifty percent, performing a jumping animation, and experiencing soft ambient light. This detailed encapsulation of an object's properties at any given moment facilitates seamless interaction, precise rendering, and accurate state synchronization within the gaming environment.

In the context of this disclosure, the term “visual effect data” refers to pre-calculated graphical information designed to enhance the visual fidelity and performance of a game on a mobile device. Visual effect data encompasses various types of pre-computed information that represent visual aspects of the game environment, creating a realistic and immersive gaming experience. This means that the visual effect data is not generated in real-time on the mobile device itself; rather, it is computed beforehand on a powerful remote server, and subsequently delivered to the mobile game, for example.

Examples of visual effect data include complex lighting simulations such as Dynamic Diffuse Global Illumination (DDGI), which defines how light bounces and illuminates objects in the scene, and pre-rendered reflections that depict the environment on surfaces, thereby enhancing realism. Additionally, visual effect data may include pre-computed shadows cast by objects, adding depth and realism, as well as ambient occlusion data that simulates the blocking of light by nearby objects, creating a sense of depth and shading.

Visual effect data may also include light probes, which capture the overall lighting environment at specific points in the scene. This data is used to create realistic lighting that can change dynamically based on player movement or weather conditions. Reflection probes capture reflections of the environment from specific points, creating realistic reflections on surfaces, even for moving objects. For example, a reflection probe placed on the floor of a room can capture reflections of the ceiling and walls, which can then be applied to any object placed on the floor.

Probe volumes represent 3D areas within the game world where probe data is captured, allowing for efficient use of probe data as only probes within the player's vicinity need to be loaded. Baked probes refer to the process of pre-calculating probe data on a powerful server before it is used in the mobile game, reducing the processing load on the mobile device itself. Probe blending involves blending data from multiple probes to create a smooth and seamless lighting or reflection effect across different areas of the scene.

By offloading these intensive calculations to a remote server, the mobile device can deliver smoother gameplay and higher visual fidelity without being constrained by its processing power and memory limitations. This approach ensures that the game maintains high visual quality and performance, providing an improved gaming experience.

In the context of the present disclosure, the term “request” refers to a message sent from the game to a remote server specifying the type and parameters of pre-calculated graphical data required to render a specific part of the game world. This request is typically triggered by a user input command, which is an action taken by the player within the game. Such actions may include entering a new level with a complex lighting environment, interacting with an object that has pre-rendered reflections, or moving the camera to reveal an area with pre-computed shadows. For example, when a player enters a dense forest with complex lighting filtering through leaves, the game sends a request for global illumination (GI) data specific to the forest area, which may include parameters like location coordinates, desired resolution, and time of day for accurate lighting calculations. However, it should be appreciated that criteria may be predetermined and saved on the cloud server, so the cloud server is able to process the received states and data accordingly without the client device sending the requests (for instance, when none of the players in the same room are operating, but the stage is moving). This ensures seamless and efficient data processing for a smooth gaming experience.

Additionally, the request may involve approaching a reflective lake, prompting the game to request probe reflection data, including parameters such as location data, desired reflection quality, and weather conditions. Similarly, interacting with a shiny weapon could trigger a request for planar reflection data specific to the weapon model, encompassing parameters like the weapon's identity (ID), mesh information, and material properties. Equipping new armor with glowing runes may combine requests for GI data to account for the runes' illumination and new texture data for the armor model.

The message transmitted to the remote server includes detailed parameters that define the precise requirements for the graphical data. These parameters may specify the location, resolution, and current lighting conditions. For example, the location parameter defines the specific area of the game world, such as the coordinates of a level or room, while the resolution parameter indicates the desired level of detail for close-up or distant views. If the lighting is dynamic, the request may include information about the time of day or specific light sources present in the scene.

The “request” thus serves a dual purpose: it acts as the user action that initiates the need for specific graphical data and as the detailed communication to the cloud server specifying the exact parameters of the pre-calculated data, such as GI, DDGI, planar reflection, and probe reflection. This precise and parameterized request allows the cloud server to efficiently provide the necessary data, enabling high-fidelity rendering and enhanced visual effects on the client device without overburdening its processing capabilities.

The generated user information including at least one of the object states, visual effect data, or requests is then transmitted from the client device 120 to a cloud server 130. As described above, via the object states or visual effect data, the user information may include specific parameters such as location, resolution, lighting conditions, and object properties for the cloud server 130 to perform the required computation and rendering tasks.

In the context of this disclosure, the term “computation task” refers to any operation that requires significant processing power to perform complex algorithms and calculations necessary to enhance the game experience. These tasks often include physics simulations, artificial intelligence (AI) behaviors, pathfinding algorithms such as A* pathfinding, and agent decisions based on machine learning. These computations determine the interactions and dynamics, often complex, within the game world. On the other hand, the term “rendering task” refers to the operations involved in generating the visual output of the game. Rendering tasks include creating detailed images from the game's 3D models and scenes, incorporating lighting effects such as global illumination, creating realistic reflections using planar and probe reflection techniques, and applying textures and shaders to surfaces. Rendering tasks produce the high-quality visuals that define the game's aesthetic and visual fidelity.

Upon receiving the user information, the cloud server 130 begins processing these computation and rendering tasks. The cloud server 130 is responsible for processing computationally intensive tasks such as GI, planar reflection, or probe reflection based on the parameters provided by the client device 120. This offloading of intensive tasks to the cloud server 130 significantly reduces the computational load on the client device 120.

Then, after performing the requested computations and rendering tasks, the cloud server 130 generates rendered results 140. These rendered results 140 encapsulate the visual output, including various graphical effects such as lighting and reflections that facilitate an immersive gaming experience.

The rendered results 140 are significantly smaller in size compared to fully rendered frames. This is because the results include pre-calculated data and parameters for the client device 120 to reconstruct the final visual output, rather than complete image files. By transmitting these compact rendered results, the system reduces the bandwidth required for data transfer between the cloud server 130 and the client device 120, as compared with conventional cloud computation for gaming.

Upon receiving the rendered results 140, the client device 120 may process them using an Application Programming Interface (API) specifically designed to interpret and apply this data. The game instance 121 running on the client device 120 may utilize the API to seamlessly integrate the rendered results 140 into the ongoing gameplay for a particular frame or frames. This integration involves applying the pre-calculated lighting, reflections, other graphical effects, and pre-computed physics to produce visuals in real-time. The use of APIs ensures that the integration of rendered results is efficient and effective, leveraging the computational power of the cloud, minimizing the load on the client device 120, and lowering the requirements on network bandwidth compared with traditional cloud gaming.

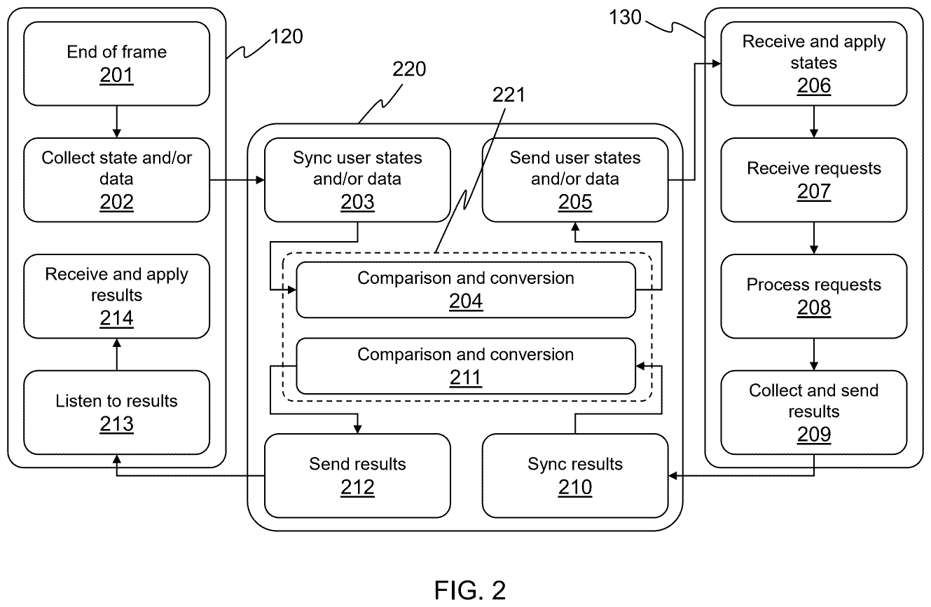

Referring now to FIG. 2, the figure illustrates a detailed process flow for cloud-based gaming, encompassing client-side operations, state synchronization, data conversion services, and cloud-based computation and rendering services. The figure outlines the interactions and data exchanges between the client device and the cloud infrastructure to optimize the gaming experience.

The process begins at the end of a game frame on the client device 120 (at 201). At this point, the game instance 121 collects the state and data for all enabled services (at 202). This collection of user information includes at least one of object states, visual effect data, or requests related to the game. The collected states and data are then transmitted to a state synchronization block 220.

Within the state synchronization block 220, the states and data from the client device 120 are synchronized (at 203). This synchronization involves aggregating information from multiple users, if necessary, for a particular frame or frames. Optionally, the state synchronization block 220 may include a data conversion block 221, which compares and converts the received data into a same format to ensure compatibility (at 204). The synchronized states and data are subsequently sent to the cloud server 130 (at 205).

The state synchronization block 220 may or may not be the same network server as the cloud server 130. In some embodiments, the state synchronization block 220 may be a server located closer to the client device 120 to ensure faster data transfer and reduced latency. This proximity enhances the speed of synchronization, ensuring that the gaming experience remains smooth and responsive. On the other hand, a more powerful server may be a different server, specifically dedicated to handling complex computation tasks and rendering high-fidelity graphics. In other embodiments, the state synchronization block 220 and the server for the computation and rendering may be the same server. In such configurations, the single server handles both the synchronization of states and data, as well as the computation and rendering tasks.

Upon receipt of the user states and data, the cloud server 130 applies them to determine the necessary computations and rendering tasks (at 206). The cloud server 130 may receive specific computation and rendering requests from the client device 120 (at 207). As described above, these requests may include tasks such as global illumination, planar reflection, or probe reflection so that the cloud server 130 knows what to process. Alternatively, criteria may be predetermined and saved on the cloud server 130, so the cloud server 130 is able to process the received states and data accordingly without the client device 120 sending the requests.

The cloud server 130 processes the received computation and rendering requests, executing computation and rendering tasks to generate the necessary graphical data (at 208). After processing, the cloud server 130 collects the graphics-related results, which may include at least one of computation results or rendering results, and prepares them for transmission back to the client device 120 (at 209).

The graphics-related results are sent back to the state synchronization block 220 (at 210), where they are synchronized, ensuring consistency and accuracy for a particular frame or frames. Optionally, the graphics-related results may be sent to the data conversion block 221 to convert the received data into a same format to ensure compatibility (at 211). The final graphics-related results after the synchronization are then transmitted back to the client device 120 (at 212).

The client device 120 receives the graphics-related results and applies them to the game instance 121. This involves updating the visuals with pre-calculated lighting, reflections, and other graphical effects. The client device 120 utilizes a listener to continuously receive and apply the graphics-related results (at 213), ensuring real-time updates and a seamless gaming experience. Finally, the client device 120 applies the graphics-related results in the game for display (at 214).

By way of example, consider a scenario in which a player moves their character into a new area with complex lighting and reflections. At the end of the frame, the client device 120 collects the character's new position and any relevant game data. This information is sent to the state synchronization block 220 to be synchronized and optionally formatted. The synchronized data is then sent to the cloud server 130. The cloud server 130 receives this data and determines that it needs to perform global illumination and reflection computations for the new area. These requests are processed, and the necessary lighting and reflection data are calculated. The results are sent back to the state synchronization block 220, synchronized, and converted if needed. Finally, the client device 120 receives the updated data and applies it, rendering the new area with realistic lighting and reflections, thus enhancing the gaming experience without overloading the client device 120.

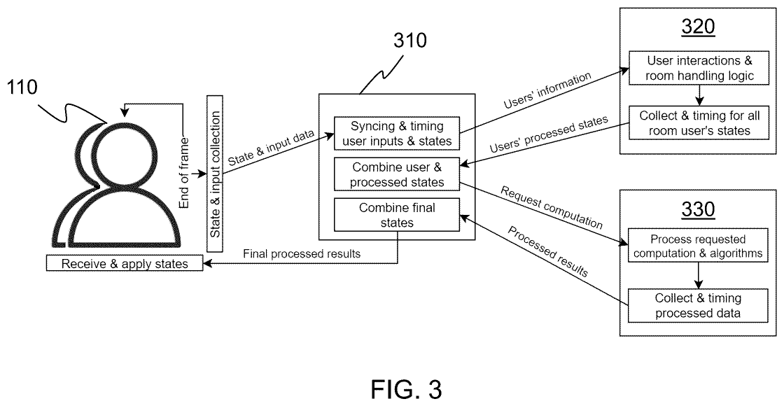

Although the state synchronization block 220 described with respect to FIG. 2 can be utilized in a single-player scenario, it is particularly advantageous for multiple players in the same channel. When states and data from different players playing in the same channel (such as the same room) are synchronized, it significantly enhances the gaming experience. This synchronization ensures that all players receive consistent and timely updates, which ensures a smooth and immersive multiplayer experience. The benefits of this synchronization will be further explained in relation to the embodiment of FIG. 3 below.

Referring now to FIG. 3, the figure illustrates a process flow for cloud-based gaming, similar to FIG. 2, but with the addition of a multi-user experience service 320. This service is integral in managing user interactions and communication within the game, especially in a multi-user environment. The multi-user experience service 320 can be hosted on the same server as the state synchronization block 220, the cloud server 130, or on a separate server, depending on the system architecture.

At the end of a game frame, the user information from multiple users 110 are sent by their client devices to a state synchronization service 310. This service is responsible for synchronizing and timing the user inputs and states, similar to the state synchronization block 220 described with respect to FIG. 2. The user information may not only include object states, visual effect data, and/or requests, but also the information such as transform values, world position, camera information, and the like. In addition to synchronizing and timing the user inputs and states, the state synchronization service 310 ensures that the data from multiple users 110 is accurately aggregated, particularly when multiple players are involved in the same game channel. The state synchronization service 310 functions as a relay, facilitating communication between the client devices and other services in the system. The user information, which may contain the object states, visual effect data, and/or requests and additional information such as connection status and latency, is then transmitted to the multi-user experience service 320.

In this embodiment, the multi-user experience service 320 determines whether the user information from each of the multiple users 110 requires cloud computing for processing. The multi-user experience service 320 handles the application-specific logic for user interactions and communication, ensuring that only relevant data from users in the same channel (such as a room or a stage in the game) is processed. There are two primary methods by which the multi-user experience service 320 identifies users in the same channel:
Developer-defined Information: In most cases, the game developer explicitly informs the server which users are in the same channel. This is achieved through APIs provided by the server, which allow the game to send messages specifying which users are currently in a particular scene. These APIs may be specific to the game engine or server framework being used. Additionally, the game may pass user data along with scene information, including unique user IDs or specific scene identifiers associated with each user. This method may be advantageous due to its accuracy and flexibility, providing a precise picture of which users are experiencing the same scene, which ensures real-time interaction and that messages are delivered to the correct users.
Server-side Scene Management: In some cases, the server manages channel information itself, especially for simpler games or those without a strong focus on real-time interaction. The server tracks user locations or levels and assumes that users in the same reported location or level are in the same channel. While this approach can be less precise for large, open-world games, it is sometimes employed for simpler scenarios.

For instance, if there is user information from many users, but only some of them are in the same room or stage of an in-game environment, it would be inefficient and wasteful to compute and render effects for users who are not in the same room or stage. Thus, the multi-user experience service 320 may proactively select data only for those users who are interacting in the same environment.

It should be appreciated that the multi-user experience service 320 may allocate users for multiple channels if needed. The multi-user experience service 320 collects and times users' states and data for all the scenes involved and then sends the updated user information back to the state synchronization service 310. The state synchronization service 310 combines all the user information that is assigned by the multi-user experience service 320 for subsequent computation and rendering and sends computation requests along with the combined user information to a cloud computation service 330. This service processes the requested rendering or computation tasks for graphical effects and physics and collects the processed results. The processed results are then timed and sent back to the state synchronization service 310.

Finally, the state synchronization service 310 sends the final results back to the client device. The client device receives and applies the processed states and data from the final results, updating the game instance with pre-calculated lighting, reflections, and other graphical effects, as well as physics.

A few scenarios may be possible with the system depicted in FIG. 3. In a first scenario, there are multiple rooms within a gaming environment, each containing multiple users or players. At the end of each game frame, the user information from these users is transmitted by their respective client devices to the state synchronization service 310 for synchronization. The synchronized user information is then transmitted to the multi-user experience service 320 for allocating user groups according to rooms and deciding user information for which room is to be processed by means of cloud computation. The state synchronization service 310 receives the allocation and forwards the computation requests to the cloud computation service 330, which performs the requested computations and sends the results back to the state synchronization service 310. The synchronized final results are transmitted back to the client devices for display.

In a second scenario, there are multiple users or players, but none of them are in the same room. In this case, user information is collected and synchronized by the state synchronization service 310, similar to the first scenario. However, since the users are not in the same room, the multi-user experience service 320 determines that cloud-assisted features and services are unnecessary for these interactions. The communication and updates may be handled locally, and the user information is not sent to the cloud computation service 330.

In a third scenario, there are multiple users or players, all of whom are in a single room. Here, the user information is transmitted by the client devices to the state synchronization service 310. Given that all users are in the same room, the multi-user experience service 320 may be bypassed. The user information is directly sent to the cloud computation service 330, where the requested computations are performed. The processed results are then sent back to the client devices via the state synchronization service 310.

These scenarios demonstrate the flexibility and efficiency of the system described in FIG. 3. Depending on the complexity of the application and the computational requirements, the system can adapt to provide optimal performance and a high-quality user experience. It should be understood that the state synchronization service 310, the multi-user experience service 320, and the cloud computation service 330 may reside on the same server or on separate servers. For example, if the three services 310, 320, and 330 are provided in the same server, they may exist as three units, such as a state synchronization unit, a multi-user experience unit, and a computing unit. Each unit may be implemented as a physical hardware component, a software process, or a combination of both, operating within a single server. This modular architecture allows for flexible deployment and efficient resource management. In addition, if the three services 310, 320, 330 are provided in the same server, the state synchronization service 310 may still function as a relay between the client devices and the other two services, so that each time when the state synchronization service 310 receives states and/or data, it can synchronize them, ensuring that all user information is accurately aggregated and processed. This relay function enables the system to handle complex multi-user interactions and rendering/computation tasks efficiently.

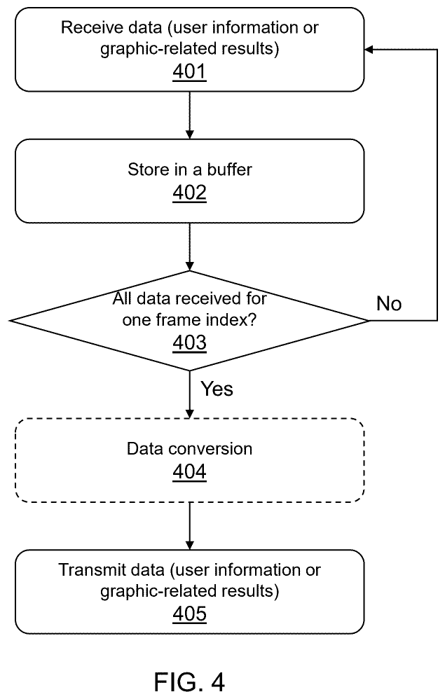

Referring now to FIG. 4, the figure illustrates a flowchart depicting the operation of the state synchronization service 310, which functions as a relay between various services and client devices. The state synchronization service 310 receives, buffers, synchronizes, and transmits data to ensure accurate and timely communication between users and services, thereby enhancing the overall gaming experience.

Initially, at 401, the state synchronization service 310 receives data, which may include user information from client devices or graphic-related results from services (e.g., the multi-user experience service 320 and the cloud computation service 330). This data may be accompanied by details specifying the intended recipients, whether they are other services or users.

Following the reception of data, at 402, the state synchronization service 310 stores the received data in a buffer. This buffering may be advantageous for managing the data flow and ensuring that all relevant data for a specific frame index is collected before further processing.

At 403, a conditional determination is made to verify whether all the data for the current frame index has been received. The state synchronization service 310 checks if it has accumulated all necessary data for the particular frame. If the data for the frame is incomplete, the process loops back to continue receiving and buffering additional data until all required information is gathered.

Once it is determined that all data for the current frame index has been received, the process optionally advances to 404, where data conversion may occur. In this operation, the format of the collected data is converted to ensure consistency across all data points. This conversion guarantees that the data is compatible and can be seamlessly integrated for subsequent processing. Additionally, the state synchronization service 310 may be notified to move on to the determination of the next frame index, thereby ensuring continuous data processing.

Subsequently, at 405, the state synchronization service 310 transmits the processed data to other services or client devices. Whether the optional data conversion step is performed or skipped, the synchronized and formatted data is sent to the relevant services or client devices as specified in the initial data reception step.

As described, the state synchronization service 310, acting as a relay between services and client devices, collects all the data for different time frames and transmits it to each relevant service or user. It is also capable of understanding the needs of each user, enabling or disabling services as required, and starting or stopping the transmission of requests and data to the services.

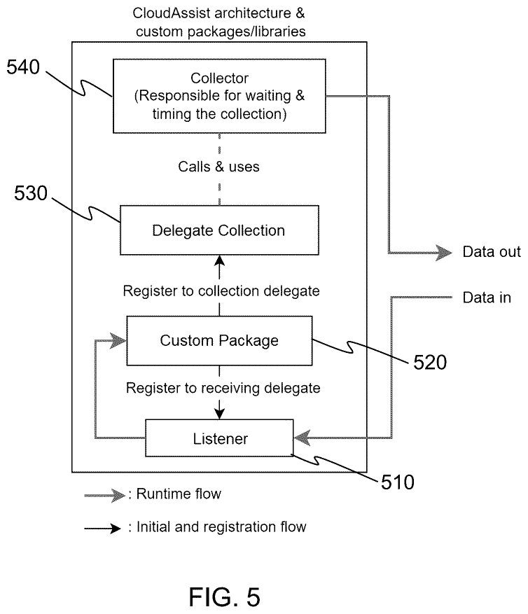

Referring now to FIG. 5, the figure illustrates an architecture of custom-made libraries and packages designed to facilitate and support the general use cases of state synchronization (such as the state synchronization block 220 described with respect to FIG. 2 and the state synchronization service 310 described with respect to FIG. 3), multi-user experience (such as the multi-user experience service 320 described with respect to FIG. 3), and computation/rendering services (such as the cloud computation service 330 described with respect to FIG. 3). This architecture comprises two main components: a collector module 540 and a listener module 510, which work together to manage data collection and distribution efficiently.

The process begins with the listener module 510, which is responsible for receiving data from services or users (data in). A custom package module 520 registers with the listener module 510 to receive the relevant data. This ensures that each custom package gets the data pertinent to its function. Once the listener module 510 receives the data, it directs the data to the appropriate custom packages at the custom package module 520.

The custom package module 520 handles specific functionalities or additional features required for processing the data. It can register back with the listener module 510 to continue receiving more data or can register with a delegate collection module 530 to further process the data.

Next, the data is passed to the delegate collection module 530, an intermediary module that manages specific tasks related to data collection. The custom package module 520 registers with the delegate collection module 530 to ensure that their data is correctly aggregated and prepared for the next stage.

The collector module 540, responsible for timing and waiting for the data to be ready, then calls upon the delegate collection module 530 to use the data it has prepared. This “call and use” interaction signifies that the collector module 540 actively invokes the delegate collection module 530 to retrieve the processed data. The collector module 540 adds timestamps and ensures the data is synchronized before sending it to the relevant services or users.

After the data collection is complete, the collector module 540 sends the data to the relevant services or users (data out). This entire process ensures that data flows efficiently through the state synchronization, from initial reception by the listener module 510, through processing by the custom package module 520 and the delegate collection module 530, to final synchronization and distribution by the collector module 540.

The bottom of FIG. 5 indicates two distinct flows within the system: the runtime flow and the initial and registration flow. The runtime flow pertains to the regular operational phase where data is actively received, processed, and transmitted by the system during its execution. This flow encompasses the continuous cycle of data management as described above. In contrast, the initial and registration flow refers to the setup phase where custom packages and libraries register with the listener module 510 and the delegate collection module 530. During this phase, the necessary modules are configured and linked to ensure that they can efficiently participate in the runtime data processing.

A few possible embodiments of the present disclosure are described in the following. In one embodiment, users are able to communicate and interact with each other in a multi-user environment using the state synchronization service and the multi-user experience service. In another embodiment, users can experience a variety of environments and situations by communicating and interacting in separate rooms and different environments, taking advantage of the features implemented in the state synchronization service and the multi-user experience service.

In another embodiment, a plurality of users benefits from performance improvements using the cloud computation service. This embodiment allows users to leverage advanced features and capabilities that would be challenging to implement on low-end devices. Another embodiment integrates the state synchronization service between users, cloud computation services, and user-interaction services, offering a system where users benefit from interactive multi-user experiences, enhanced consistency, cross-platform support, and fair usage of resources.

Additionally, developers and content creators can benefit from the integrated solution comprising packages, libraries, and provided APIs. This setup enables them to add more features, improve user experience, and reduce development time.

The present disclosure also encompasses implementations using one or more non-transitory computer-readable storage devices comprising computer-executable instructions. These instructions, when executed by one or more circuits, cause the circuits to perform actions such as receiving user information from at least one user, determining whether this information requires cloud computing based on the game channel, and transmitting the user information to a computing server for processing to generate graphics-related results. In this context, the term “circuit” refers to an arrangement of electronic components, such as transistors, resistors, capacitors, and integrated circuits, which are configured to perform specific tasks within a computing device. These circuits can be part of a central processing unit (CPU), graphics processing unit (GPU), application-specific integrated circuit (ASIC), or field-programmable gate array (FPGA). The circuits work in conjunction with the computer-executable instructions stored on the non-transitory computer-readable storage devices to carry out the required computations and data processing tasks. This architecture ensures that computational tasks are efficiently managed and distributed, thereby enhancing overall system performance by leveraging the combined capabilities of the cloud and local hardware resources. The circuits execute the instructions to manage data flow, synchronize states, and handle rendering tasks, ensuring seamless and efficient operation of the gaming environment.

The present disclosure presents a comprehensive solution for game developers, designed to integrate seamlessly with popular game engines. It leverages a unique client-cloud architecture, allowing developers to offload intensive computation and rendering tasks to the cloud. The platform offers real-time synchronization of game states between client and cloud, ensuring that components remain consistent across various environments. It supports advanced features like reflections, A* pathfinding algorithms, and other computation-intensive tasks, which are processed in the cloud to reduce the load on client devices. Additionally, the platform is equipped with a unit conversion system that facilitates smooth interoperability between different types of game engines, making it a versatile tool for developers working in mixed-engine environments. The flexibility to extend and customize game components enables developers to tailor the platform to their specific needs by adding new components or computational services. This platform is beneficial for developing both single-player and multiplayer games, offering scalability, improved performance, and enhanced gameplay experiences.

Furthermore, a Cross-Engine Synchronization and Conversion Software Development Kit (SDK) may be utilized. This SDK is specifically designed for game developers who work with different game engines but need to maintain consistency and interoperability between various systems. The SDK acts as a bridge, allowing seamless communication and data transfer between engines like Unity and Unreal. It includes tools for synchronizing game states and components between client-side engines and cloud-based systems. The SDK's capability lies in its ability to convert units and data formats across different game engines, solving a common challenge faced by developers in multi-engine environments. It also supports the extension of game components, meaning developers can integrate their custom components and ensure they are properly synced and rendered, regardless of the engine used. This SDK is a useful tool for game studios and indie developers who seek to create games that can run across multiple platforms without sacrificing performance or compatibility. It simplifies the development process and reduces the need for engine-specific adjustments.

The present disclosure is directed to a practical application by addressing specific challenges in the field of cloud-based gaming and multi-user environments. It improves the functioning of a computer by optimizing the use of computing resources, reducing latency, and improving the overall user experience. By offloading intensive computing and rendering tasks to the cloud, the system ensures that even low-end devices can run high-fidelity games with complex graphics and real-time interactions. This not only expands the accessibility of high-quality gaming experiences, but also extends the life cycle of older hardware, making the solution economically beneficial.

In addition, the present disclosure improves the functioning of a computer by leveraging a unique client-cloud architecture that enables real-time synchronization of game states, efficient data handling, and seamless integration of different game engines. This architecture reduces the computational load on client devices, allowing them to operate more efficiently and effectively. The use of pre-calculated graphical data, such as lighting and reflections, minimizes the need for real-time processing on the client side, reducing the demand on local hardware resources. The ability to synchronize user states and inputs across multiple devices and environments ensures a consistent and immersive gaming experience.

It should be understood that various modifications, alterations, and adaptations may be made to the specific elements and configurations disclosed, including but not limited to dimensions, materials, positions, and operational mechanisms, without departing from the essence and scope of the disclosure.

The terminology used herein is only for the purpose of describing particular embodiments and is not intended to be limiting. Accordingly, as used herein, the singular forms “a”, “an”, and “the” are intended to include the plural forms as well, unless the context clearly indicates otherwise. It will be further understood that the terms “comprises” and “comprising”, when used in this specification, specify the presence of one or more stated features, integers, steps, operations, elements, and components, but do not preclude the presence or addition of one or more other features, integers, steps, operations, elements, components, and groups. Directional terms such as “top”, “bottom”, “upwards”, “downwards”, “vertically”, and “laterally” are used in the following description for the purpose of providing relative reference only, and are not intended to suggest any limitations on how any article is to be positioned during use, or to be mounted in an assembly or relative to an environment. Additionally, the term “connect” and variants of it such as “connected”, “connects”, and “connecting” as used in this description are intended to include indirect and direct connections unless otherwise indicated. For example, if a first device is connected to a second device, that coupling may be through a direct connection or through an indirect connection via other devices and connections. Similarly, if the first device is communicatively connected to the second device, communication may be through a direct connection or through an indirect connection via other devices and connections.

Use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

It is contemplated that any part of any aspect or embodiment discussed in this specification can be implemented or combined with any part of any other aspect or embodiment discussed in this specification, so long as such those parts are not mutually exclusive with each other.

While every effort has been made to provide a detailed and accurate description of the disclosure herein, it should be noted that the scope of the disclosure is not limited to the exact configurations and embodiments described. The description provided is intended to illustrate the principles of the disclosure and not to limit the disclosure to the specific embodiments illustrated. It is intended that the scope of the disclosure be defined by the appended claims, their equivalents, and their potential applications in other fields.

What is claimed is:

1. A method comprising:
receiving user information from at least one user, the user information comprising at least one of an object state or visual effect data related to a game;
determining, based on a channel of the game in which the at least one user is playing, whether the user information of the at least one user requires cloud computing for processing; and
in response to determining that the user information requires cloud computing, transmitting the user information of the at least one user to a computing server for processing the user information to generate graphics-related results for the channel.

2. The method of claim 1, wherein, in response to determining that the user information requires cloud computing, the computing server processes at least one of the object state or the visual effect data using a request from the at least one user.

3. The method of claim 2, wherein, in response to determining that the user information requires cloud computing, the computing server processes the object state or the visual effect data of the at least one user that has been changed compared to a previous frame.

4. The method of claim 1, wherein determining whether the user information of the at least one user requires cloud computing for processing comprises identifying one or more users of the at least one user in a same channel of the game as requiring cloud computing.

5. The method of claim 1, further comprising caching the received user information and performing the determination upon receiving all object states and visual effect data of all of the at least one user in a same channel of the game for a frame.

6. The method of claim 1, further comprising converting a format of at least one of the object state or the visual effect data of the at least one user to ensure that the at least one of the object state or the visual effect data of all of the at least one user have a same format.

7. The method of claim 1, further comprising receiving a request from the at least one user, wherein the request is for a rendering process to be performed by the computing server, the rendering process being at least one of global illumination, planar reflection, or probe reflection;
wherein the object state comprises at least one of animation state, physics state, health state, inventory state, power state; and
wherein the visual effect data comprises at least one of transform data, light probes, reflection probes, probe volumes, baked probes, or probe blending.

8. The method of claim 1, wherein the graphics-related results comprise rendering results and computation results, the rendering results being information on at least one of global illumination, planar reflection, or probe reflection, and the computation results being information on at least one of an A* pathfinding agent or a machine learning-powered agent.

9. The method of claim 1, further comprising:
receiving the graphics-related results from the computing server; and
transmitting the graphics-related results to a user device associated with the at least one user for loading on the user device.

10. A server comprising:
a state synchronization unit for receiving user information from at least one user, the user information comprising at least one of an object state or visual effect data related to a game;
a multi-user experience unit for determining, based on a channel of the game in which the at least one user is playing, whether the user information of the at least one user requires cloud computing for processing; and
a computing unit for, in response to determining that the user information requires cloud computing, receiving the user information of the at least one user and processing the user information to generate graphics-related results for the channel.

11. The server of claim 10, wherein, in response to determining that the user information requires cloud computing, the computing unit processes at least one of the object state or the visual effect data using a request from the at least one user.

12. The server of claim 10, wherein the multi-user experience unit identifies one or more users of the at least one user in a same channel of the game as requiring cloud computing.

13. The server of claim 10, wherein the state synchronization unit further receives a request from the at least one user, wherein the request is for a rendering process to be performed by the computing unit, the rendering process being at least one of global illumination, planar reflection, or probe reflection;
wherein the object state comprises at least one of animation state, physics state, health state, inventory state, power state; and
wherein the visual effect data comprises at least one of transform data, light probes, reflection probes, probe volumes, baked probes, or probe blending.

14. The server of claim 10, wherein the graphics-related results comprise rendering results and computation results, the rendering results being information on at least one of global illumination, planar reflection, or probe reflection, and the computation results being information on at least one of an A* pathfinding agent or a machine learning-powered agent.

15. A system comprising:
a user device associated with at least one user;
a state synchronization server for receiving user information from the at least one user, the user information comprising at least one of an object state or visual effect data related to a game;
a multi-user experience server for determining, based on a channel of the game in which the at least one user is playing, whether the user information of the at least one user requires cloud computing for processing; and
a computing server for, in response to determining that the user information requires cloud computing, receiving the user information of the at least one user and processing the user information to generate graphics-related results for the channel.

16. The system of claim 15, wherein, in response to determining that the user information requires cloud computing, the computing server processes at least one of the object state or the visual effect data using a request from the at least one user.

17. The system of claim 15, wherein the multi-user experience server identifies one or more users of the at least one user in a same channel of the game as requiring cloud computing.

18. The system of claim 15, wherein the state synchronization server further receives a request from the at least one user, wherein the request is for a rendering process to be performed by the computing server, the rendering process being at least one of global illumination, planar reflection, or probe reflection;
wherein the object state comprises at least one of animation state, physics state, health state, inventory state, power state; and
wherein the visual effect data comprises at least one of transform data, light probes, reflection probes, probe volumes, baked probes, or probe blending.

19. The system of claim 15, wherein the graphics-related results comprise rendering results and computation results, the rendering results being information on at least one of global illumination, planar reflection, or probe reflection, and the computation results being information on at least one of an A* pathfinding agent or a machine learning-powered agent.

20. The system of claim 15, wherein the state synchronization server, the multi-user experience server, and the computing server are spatially distinct servers.
